(19) United States
(12) Patent Application Publication
(10) Pub. No.: US 2007/0278079 A1
(43) Pub. Date: Dec. 6, 2007

(54) Key

(75) Inventor: Ling-Hsi Chao, Taipei County (TW)

Correspondence Address: QUINTERO LAW OFFICE, PC, 2210 MAIN STREET, SUITE 200, SANTA MONICA, CA, 90405, US

(73) Assignee: DARFON ELECTRONICS CORP., TAOYUAN (TW)

(21) Appl. No.: 11/755,687

(22) Filed: May 30, 2007

(30) Foreign Application Priority Data
Jun. 1, 2006 (TW) TW95119382

(51) Int. Cl. H01H 13/70

(52) U.S. Cl. 200/345

(57) ABSTRACT

A key. A scissors linking mechanism is disposed on a base plate and includes a first linking member and a second linking member. The first linking member pivots on the second linking member and includes a first end and a second end. The second linking member includes a third end and a fourth end. The second end includes a first guide pillar. The fourth end includes a second guide pillar. A keycap is disposed on the scissors linking mechanism and includes two first slides, two second slides, and a guiding protrusion. The first slides oppose each other and correspond to the first guide pillar. The second slides oppose each other and correspond to the second guide pillar. The guiding protrusion is disposed between the first slides. The first guide pillar enters the first slides through the guiding protrusion, enabling the second guide pillar to enter the second slides.

### BACKGROUND OF THE INVENTION

1. Field of the Invention

The invention relates to a key, and more particularly to an easily assembled key.

2. Description of the Related Art

Referring to FIG. 1, a conventional key 1 comprises a keycap 11 and a scissors linking mechanism 12. Here, a resilient member is omitted for simplicity. The keycap 11 comprises slides 11a and engaging bases 11b. The scissors linking mechanism 12 comprises a first linking member 12a and a second linking member 12b. When the keycap 11 and scissors linking mechanism 12 are assembled, the slides 11a of the keycap 11 aim at a guide pillar 12a′ of the first linking member 12a and the guide pillar 12a′ then slides into the slides 11a. In another aspect, the engaging bases 11b of the keycap 11 aim at a guide pillar 12b′ of the second linking member 12b and the guide pillar 12b′ is then engaged in the engaging bases 11b. Assembly of the key 1 is thus complete.

Accordingly, two steps are required for assembly between the keycap 11 and the scissors linking mechanism 12, causing inconvenience of assembly and increasing assembly time thereof.

Hence, there is a need for a key simplifying assembly between a keycap and a scissors linking mechanism and reducing assembly time thereof.

### BRIEF SUMMARY OF THE INVENTION

A detailed description is given in the following embodiments with reference to the accompanying drawings.

An exemplary embodiment of the invention provides a key comprising a base plate, a scissors linking mechanism, and a keycap. The scissors linking mechanism is disposed on the base plate and comprises a first linking member and a second linking member. The first linking member pivots on the second linking member and comprises a first end and a second end. The second linking member comprises a third end and a fourth end. The first end is opposite the second end. The third end is opposite the fourth end. The first and third ends pivot on the base plate. The second end comprises a first guide pillar. The fourth end comprises a second guide pillar. The keycap is disposed on the scissors linking mechanism and comprises two first slides, two second slides, and a guiding protrusion. The first slides oppose each other and correspond to the first guide pillar. The second slides oppose each other and correspond to the second guide pillar. The guiding protrusion is disposed between the first slides. The first guide pillar enters the first slides through the guiding protrusion, enabling the second guide pillar to enter the second slides.

The guiding protrusion comprises a guiding slope opposing the first slides. The first guide pillar slides through the guiding slope to enter the first slides.

### BRIEF DESCRIPTION OF THE DRAWINGS

The invention can be more fully understood by reading the subsequent detailed description and examples with references made to the accompanying drawings, wherein:

FIG. 1 is a schematic partial cross section of a conventional key;

FIG. 2 is a schematic partial cross section of a key of the invention;

FIG. 3 is a schematic top view of a keycap of the key of the invention;

FIG. 4A is a partial top view of the key of the invention;

FIG. 4B is a schematic partial cross section of FIG. 4A; and

FIG. 5 is another partial top view of the key of the invention.

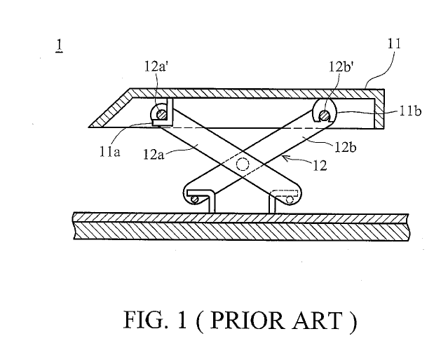

### DETAILED DESCRIPTION OF THE INVENTION

The following description is of the best-contemplated mode of carrying out the invention. This description is made for the purpose of illustrating the general principles of the invention and should not be taken in a limiting sense. The scope of the invention is best determined by reference to the appended claims.

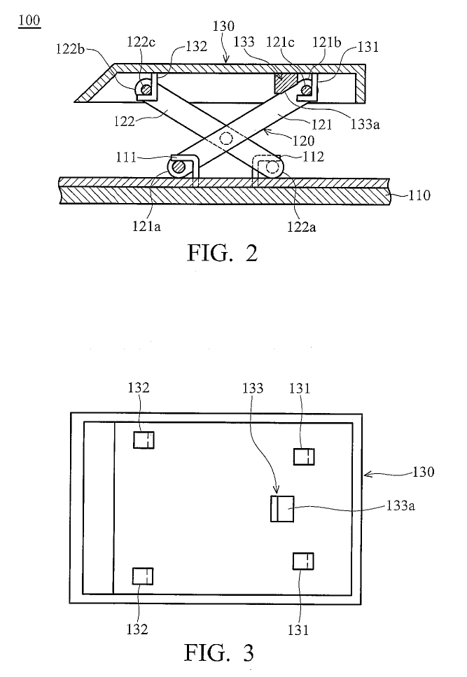

Referring to FIG. 2, a key 100 comprises a base plate 110, a scissors linking mechanism 120, and a keycap 130. Here, a resilient member is omitted for simplicity.

As shown in FIG. 2, the scissors linking mechanism 120 is disposed on the base plate 110 and comprises a first linking member 121 and a second linking member 122. The first linking member 121 pivots on the second linking member 122 and comprises a first end 121a and a second end 121b. The second linking member 122 comprises a third end 122a and a fourth end 122b. The first end 121a is opposite the second end 121b. The third end 122a is opposite the fourth end 122b. The first end 121a and third end 122a pivot on the base plate 110. Namely, the first end 121a and third end 122a are rotatably disposed in support bases 111 and support bases 112 of the base plate 110, respectively. Additionally, the second end 121b of the first linking member 121 comprises a first guide pillar 121c, and the fourth end 122b of the second linking member 122 comprises a second guide pillar 122c.

As shown in FIG. 2 and FIG. 3, the keycap 130 is disposed on the scissors linking mechanism 120 and comprises two first slides 131, two second slides 132, and a guiding protrusion 133. The first slides 131 oppose each other and correspond to the first guide pillar 121c of the first linking member 121. The second slides 132 oppose each other and correspond to the second guide pillar 122c of the second linking member 122. Specifically, the guiding protrusion 133 is disposed between the first slides 131 and comprises a guiding slope 133a opposing (openings of) the first slides 131.

The following description is directed to assembly between the keycap 130 and the scissors linking mechanism 120 (or assembly of the key 100).

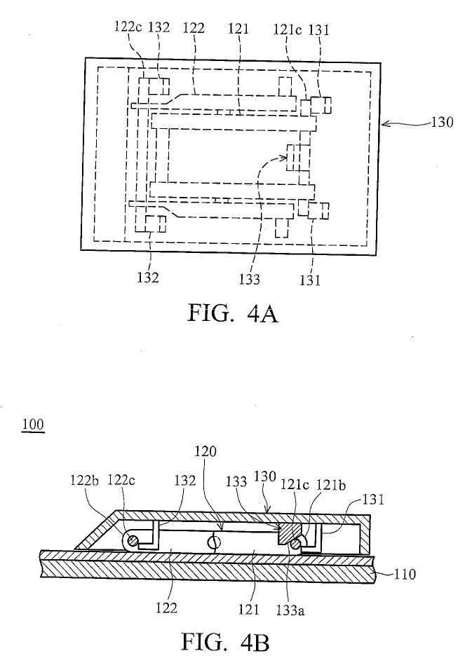

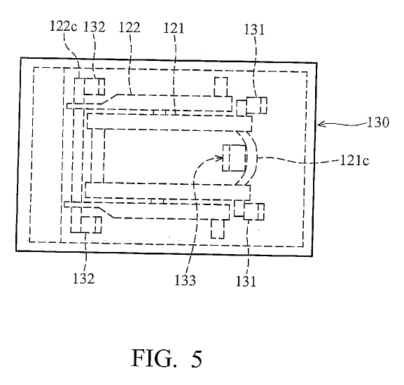

As shown in FIG. 4A and FIG. 4B, the keycap 130 is placed above the scissors linking mechanism 120, with openings of the first slides 131 and second slides 132 of the keycap 130 respectively corresponding to the first guide pillar 121c of the first linking member 121 and second guide pillar 122c of the second linking member 122. Here, the first guide pillar 121c of the first linking member 121 is located on the guiding slope 133a of the guiding protrusion 133. Then, the keycap 130 is directly pressed toward the scissors linking mechanism 120. At this point, as shown in FIG. 5, the first guide pillar 121c of the first linking member 121 slides on the guiding slope 133a of the guiding protrusion 133 of the keycap 130 and the first guide pillar 121c is elastically deformed by compression of the guiding protrusion 133 (or guiding slope 133a). Specifically, when the first guide pillar 121c of the first linking member 121 slides on the guiding slope 133a of the guiding protrusion 133, the first guide pillar 121c (of the first linking member 121) and second guide pillar 122c (of the second linking member 122) respectively and gradually move toward the openings of the first slides 131 and second slides 132 by the compression of the guiding protrusion 133 (or guiding slope 133a). Then, the first guide pillar 121c of the first linking member 121 completely enters the first slides 131 through the openings thereof, and the second guide pillar 122c of the second linking member 122 completely enters the second slides 132 through the openings thereof. As shown in FIG. 2, the assembly between the keycap 130 and the scissors linking mechanism 120 (or the assembly of the key 100) is complete.

In conclusion, in the disclosed key, only one step is required for the assembly between the keycap and the scissors linking mechanism. Thus, the assembly of the key is simplified and time for assembling the same is reduced.

While the invention has been described by way of example and in terms of preferred embodiment, it is to be understood that the invention is not limited thereto. To the contrary, it is intended to cover various modifications and similar arrangements (as would be apparent to those skilled in the art). Therefore, the scope of the appended claims should be accorded the broadest interpretation so as to encompass all such modifications and similar arrangements.

What is claimed is:

1. A key, comprising:
a base plate;
a scissors linking mechanism disposed on the base plate and comprising a first linking member and a second linking member, wherein the first linking member pivots on the second linking member and comprises a first end and a second end, the second linking member comprises a third end and a fourth end, the first end is opposite the second end, the third end is opposite the fourth end, the first and third ends pivot on the base plate, the second end comprises a first guide pillar, and the fourth end comprises a second guide pillar; and
a keycap disposed on the scissors linking mechanism and comprising two first slides, two second slides, and a guiding protrusion, wherein the first slides oppose each other and correspond to the first guide pillar, the second slides oppose each other and correspond to the second guide pillar, the guiding protrusion is disposed between the first slides, and the first guide pillar enters the first slides through the guiding protrusion, enabling the second guide pillar to enter the second slides.

2. The key as claimed in claim 1, wherein the guiding protrusion comprises a guiding slope opposing the first slides, and the first guide pillar slides through the guiding slope to enter the first slides.
